(19) United States
(12) Patent Application Publication
(10) Pub. No.: US 2014/0103127 A1
(43) Pub. Date: Apr. 17, 2014

(54) TEMPERATURE-CONTROLLING WATER VALVE

(71) Applicant: Tsai-Chen YANG, Taichung (TW)

(72) Inventor: Tsai-Chen YANG, Taichung (TW)

(21) Appl. No.: 13/651,310

(22) Filed: Oct. 12, 2012

(51) Int. Cl. G05D 23/00

(52) U.S. Cl. 236/91 R

(57) ABSTRACT

A temperature-controlling water valve includes a main body, a main valve, and a screw element to screw with a threaded portion on the main body. The main body defines a height direction and a horizontal direction perpendicular to each other. The main body has a first end and an opposite second end along the height direction. A cold and a hot water inlets opposite to the first end are formed at the second end. Cold water and hot water are mixed in the main body and flow out from an outlet between the first and the second ends along the horizontal direction. The main valve disposed in the main body is able to regulate water amount flowing in, and one end of the main valve is exposed above the second end. Thereby, the present invention is able to be installed easily.

### BACKGROUND OF THE INVENTION

1. Field of the Invention

The present invention relates to a temperature-controlling water valve, more specifically to a water valve which is able to be installed in an edge of bathtub with a small width.

2. Description of the Prior Art

A conventional water faucet in bathroom usually has a faucet and a handle which are arranged in a cross manner, as disclosed in patent TW 586598. However, the inlet pipes are usually exposed to result risk of burning by touching accidentally. In addition, larger room is needed due to the cross arrangement. Also, the cross arrangement is hard to be installed on an edge of bathtub and has to be installed inside the wall. Thus, difficulty of installation is promoted.

On the other hand, a conventional faucet is unable to maintain outflowing water at a predetermined temperature. When temperature of original water is changed by weather or other factors, temperature of outflowing water may be changed too. Thus, a user should adjust the ratio of amount of cold water and hot water every time, and time and water resource are wasted. Furthermore, if temperature of original hot water is not static, the outflowing water is unable to be maintained at a static temperature. However, most conventional thermo-static adjustment devices should be installed on water heaters, so a user can not adjust the temperature of water simultaneously when using.

### SUMMARY OF THE INVENTION

The main object of the present invention is to provide a temperature-controlling water valve which is adapted for being installed in a narrower edge of bathtub and is easy to be installed.

To achieve the above and other objects, a temperature-controlling water valve of the present invention includes a main body, a main valve, and a screw element.

The main body defines a height direction and a horizontal direction perpendicular to the height direction. The main body forms a receiving room. The main body has a first end and an opposite second end along the height direction. A threaded portion is formed on an outer wall at the first end to be screwed with the screw element. A cold water inlet and a hot water inlet are formed at the second end and are both opposite to the first end. The cold water inlet and the hot water inlet allow cold water and hot water to enter the main body along the height direction respectively. The main body further forms an outlet between the first end and the second end. Cold water entering from the cold water inlet and hot water entering from the hot water inlet are mixed in the main body and then flow out via the outlet along the horizontal direction.

The main valve is disposed in the receiving room and has a third end and an opposite fourth end wherein the fourth end positionally corresponds to the second end, and the third end is exposed above the first end of the main body. The main valve is able to regulate water amount flowing from the cold water inlet and the hot water inlet.

Thereby, the temperature-controlling water valve of the present invention is able to be installed in a bathtub edge in a smaller width. When the present invention is installed in the bathtub edge, the threaded portion is partially exposed above the bathtub edge so that the screw element is able to screw with the threaded portion outside the bathtub edge to position the main body. In addition, the main valve is exposed outside the main body. Thereby, when the main valve is broken and needs repairing, the main valve can be removed outside the bathtub edge without removing the screw element in advance. Thus, inconvenience due to dissembling too many components can be avoided. Besides, the inlets are located below the outlet so as to facilitate engaging with water pipes.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of the present invention;

FIG. 2 is a breakdown drawing of the present invention;

FIG. 3 is a profile of the present invention;

FIG. 4 is an illustration of the present invention.

### DETAILED DESCRIPTION OF THE PREFERRED EMBODIMENTS

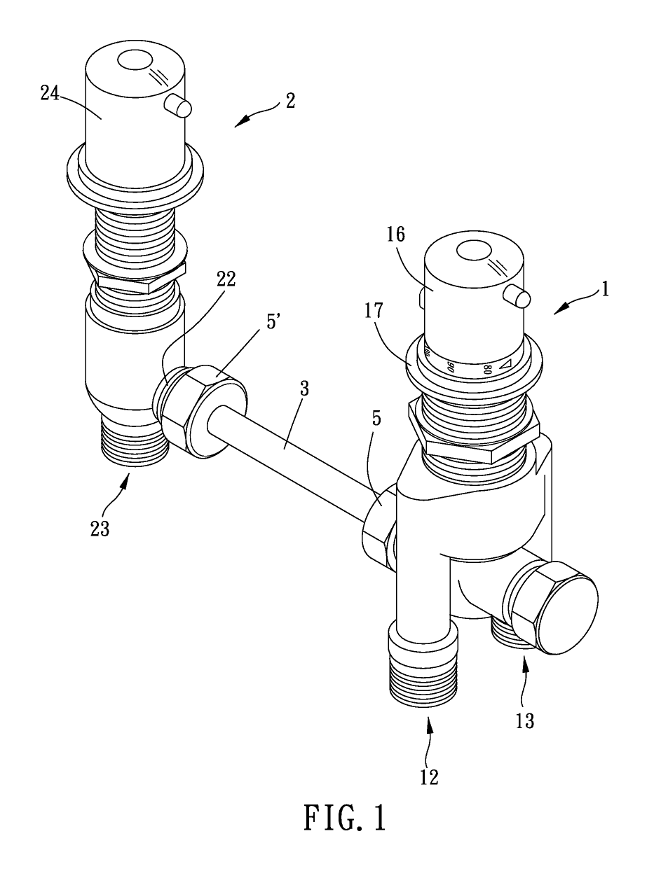

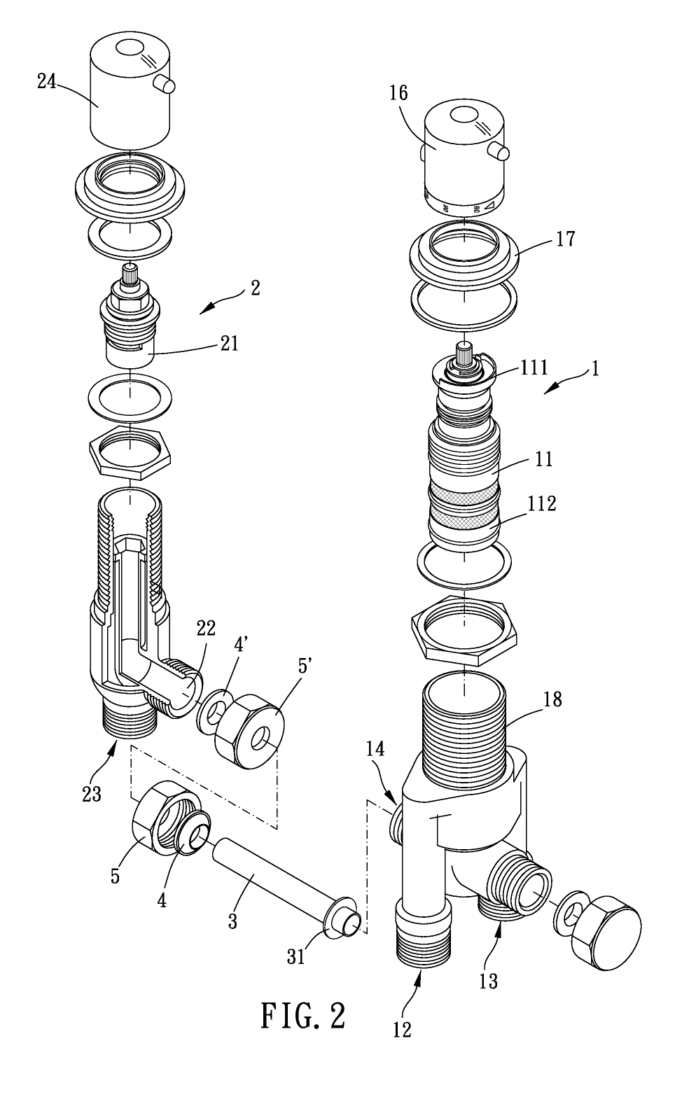

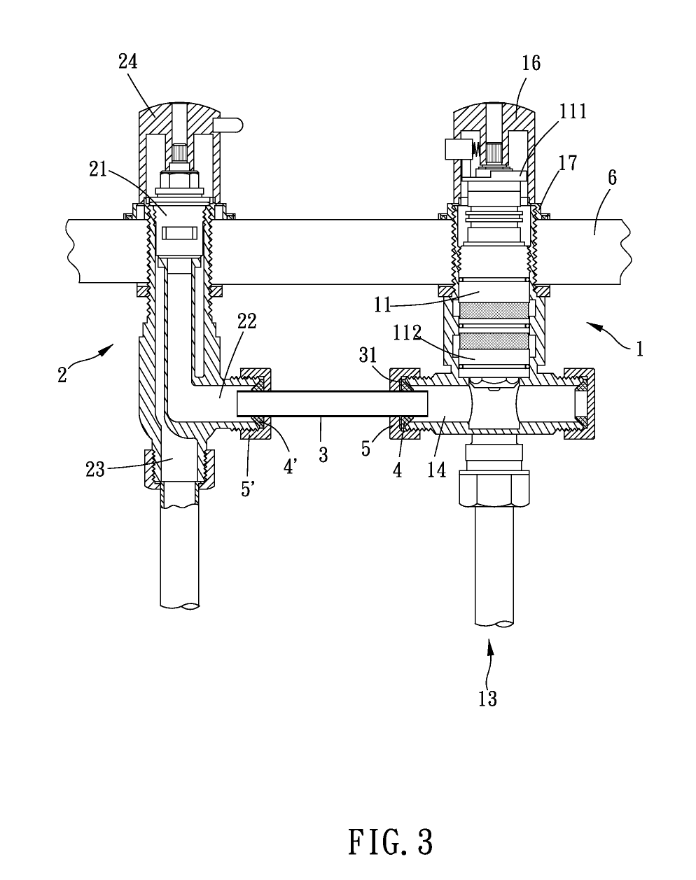

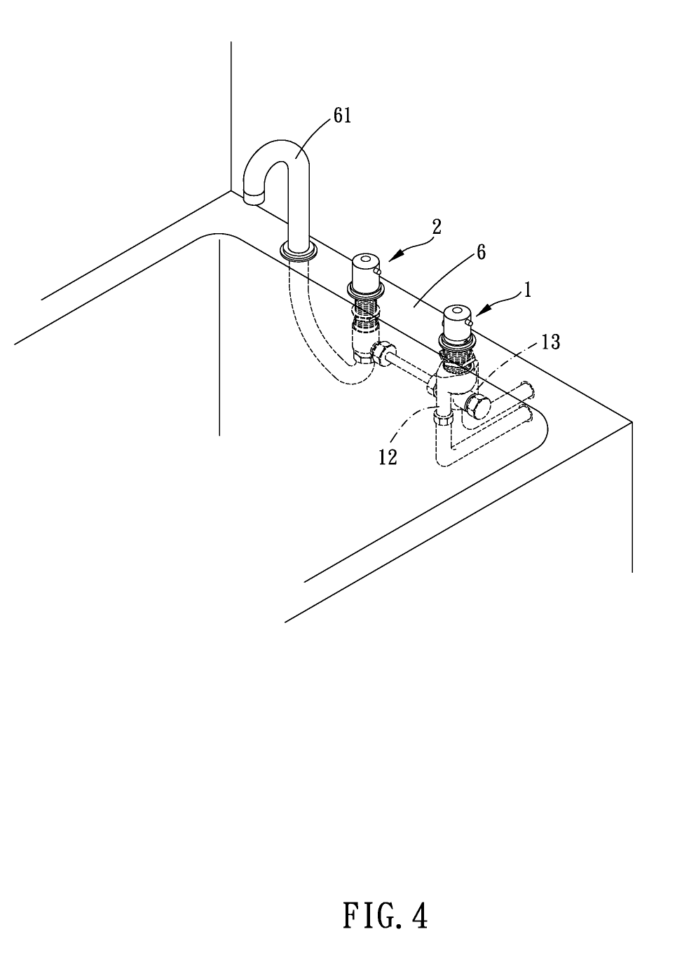

Please refer to FIG. 1 to FIG. 4. The temperature-controlling water valve of the present invention includes a main body 1, a main valve 11, and a screw element 17.

The main body 1 defines a height direction and a horizontal direction perpendicular to the height direction. The main body 1 encloses a receiving room and has a first end and an opposite second end along the height direction. A threaded portion 18 is formed on an outer wall of the main body 1 at the first end to screw with the screw element 17. The main body 1 has a cold water inlet 12 and a hot water inlet 13 at the second end. The cold water inlet 12 and the hot water inlet 13 both face opposite to the first end and are able to allow cold water and hot water to flow into the main body 1 along the height direction upward. The main body 1 further has an outlet 14 between the first end and the second end. Cold water from the cold water inlet 12 and hot water from the hot water inlet 13 are mixed in the main body 1 and flow out via the outlet 14 along the horizontal direction. Specifically, when installed in a bathtub edge 6, only part of the main body 1 with part of the threaded portion is disposed in the bathtub edge 6, and the screw element 17 is screwed with the threaded portion 18 outside the bathtub edge 6 and abuts against an outer surface of the bathtub edge 6 to position the main body 1 firmly. Optionally, one more screw element can be installed inside the bathtub edge 6 and be screwed with the threaded portion 18 to clamp the bathtub edge 6.

The main valve 11 is disposed in the receiving room and has a third end 111 and an opposite fourth end 112. The fourth end 112 positionally corresponds to the second end of the main body 1, and the third end 111 is exposed above the first end of the main body 1. The main valve 11 is able to regulate amount of cold water from the cold water inlet 12 and amount of hot water from the hot water inlet 13. More preferably, the main valve 11 is able to detect temperature of mixed water in the main body 1 and to automatically regulate amount of water flowing from the cold water inlet 12 and the hot water inlet 13 so as to maintain a constant temperature of mixed water in the main body 1. For instance, a conventional temperature-controlling rod can be employed. The temperature-controlling rod is able to alternatively block the cold water inlet and the hot water inlet by different ratio to regulate amount of water flowing in. On the other hand, the main body further has a control portion 16 which is able to set up a predetermined temperature, and the main valve 11 can automatically detect and keep the mixed water in the main body at the predetermined temperature.

In the major embodiment of the present invention, the temperature-controlling water valve can be used in company with a flow valve 2. More preferably, the flow valve 2 also defines a height direction and a transverse direction perpendicular to its height direction. The transverse direction is parallel to the horizontal direction of the main body 1, and the height direction of the flow valve 2 is parallel to the height direction of the main body 1. The flow valve 2 includes a valve body 21 inside, a mixed water inlet 22, and a terminal outlet 23. The terminal outlet 23 faces toward the outlet 14 of the main body and communicates with the outlet 14 via a connecting pipe 3 which extends along the transverse direction. The terminal outlet 23 is formed on a bottom of the flow valve 2 downward and allows water to flow out from the flow valve along the height direction of the flow valve 2. The valve body 21 is able to regulate amount of water flowing out via the terminal outlet 23. More preferably, the flow valve 2 has an adjusting portion 24 on its top. The adjusting portion 24 is connected with the valve body 21 and is able to control the valve body 21 so as to regulate amount of water flowing out via the terminal outlet 23.

The connecting pipe 3 has an external diameter equal to or smaller than sizes of the outlet 14 and the mixed water inlet 22 so that two opposite ends of the connecting pipe 3 are able to be inserted into the outlet 14 and the mixed water inlet 22. Two anti-leak annular pads 4, 4′ are disposed around the connecting pipe 3 at two ends of the connecting pipe 3. Each annular pad 4, 4′ is sandwiched between the connecting pipe 3 and one of the mixed water inlet 22 and the outlet 14. Furthermore, two nuts 5, 5′ are disposed around the connecting pipe 3. The nuts 5, 5′ cover the annular pads 4, 4′ respectively and are screwed around the mixed water inlet 22 and the outlet 14. In addition, the connecting pipe 3 further forms a blocking flange 31 which is sandwiched between one of the annular pads 4 and corresponding nut 5 so that an end of the connecting pipe 3 having the blocking flange 31 is unable to further insert into the outlet 14 or the mixed water inlet 22. On the contrary, an end of the connecting pipe 3 without the blocking flange 31 is able to alternatively insert into the outlet 14 or the mixed water inlet 22 to regulate a distance between the main body 1 and the flow valve 2 for practical use. Also, the blocking flange 31 helps prevent leaking and disassembling.

Under controlled by the main valve 11, a proper ratio of cold water and hot water can flow into the main body 1 from the cold water inlet 12 and the hot water inlet 13 and be mixed in the main body 1 at the predetermined temperature. The mixed water flows into the flow valve 2 via the outlet 14, the connecting pipe 3, and the mixed water inlet 22. Amount of water flowing out via the terminal outlet 23 can be adjusted by the adjusting portion 24.

As a result of that the main body and the flow valve are disposed spacedly in the bathtub edge, that all flowing directions of water are not parallel to a width of the bathtub edge, and that the connecting pipe is parallel to an extending direction of the bathtub edge, the width of the bathtub edge can be minimized to save rooms. Moreover, temperature and flow of water can be adjusted respectively to prevent that water temperature is changed accidentally when a user is adjusting water flow. Besides, the piping of water is entirely concealed inside the bathtub edge. Thus, space is saved, a simplified appearance is provided, and burn due to accidentally touching hot water piping is prevented. Furthermore, the main valve is exposed outside the main body, so the screw element doesn't have to be detached when displacing the main valve so that disassembling is prevented. On the other hand, inlets below the connecting pipe can be connected with other inlet pipes more easily.

What is claimed is:

1. A temperature-controlling water valve including:
a main body, defining a height direction and a horizontal direction perpendicular to the height direction, the main body enclosing a receiving room, the main body having a first end and an opposite second end along the height direction, the main body forming a threaded portion on an outer wall near the first end, a main body further forming a cold water inlet and a hot water inlet near the second end, the cold water inlet and the hot water inlet both facing rearward the first end and allowing cold water and hot water to enter the main body along the height direction, the main body having an output between the first end and the second end, cold water from the cold water inlet and hot water from the hot water inlet being mixed in the main body and flowing out along the horizontal direction from the outlet;
a main valve, received in the receiving room and having a third end and an opposite fourth end, the fourth end positionally corresponding to the second end of the main body, the third end of the main valve protruding above the first end of the main body, the main valve being able to regulate cold water amount from the cold water inlet and hot water amount from the hot water inlet;
a screw element, screwed with the threaded portion.

2. The temperature-controlling water valve of claim 1, wherein the main valve is able to automatically detect water temperature in the main body and to automatically regulate cold water amount from the cold water inlet and hot water amount from the hot water inlet to maintain the mixed water in the main body at a predetermined temperature.

3. The temperature-controlling water valve of claim 2, wherein the main body has a control portion, the control portion is able to set up the predetermined temperature.
